(19) United States
(12) Patent Application Publication
(10) Pub. No.: US 2009/0047025 A1
(43) Pub. Date: Feb. 19, 2009

(54) Multiple Electrical Level Dispersion Tolerant Optical Apparatus

(76) Inventors: Jin Hong, Saratoga, CA (US); Song Shang, Polo Alto, CA (US)

Correspondence Address: Jin Hong, 19796 Bonnie Ridge Way, Saratoga, CA, 95070, US

(21) Appl. No.: 12/132,616

(22) Filed: Jun. 4, 2008

Related U.S. Application Data
(60) Provisional application No. 60/933,039, filed on Jun. 4, 2007.

(51) Int. Cl. H04B 10/00

(52) U.S. Cl. 398/135

(57) ABSTRACT

An optical apparatus consisting of a transmitter, receiver, or transceiver, utilizing a multiple level special electrical layer modulation and/or demodulation scheme to significantly lower the bandwidth required for high speed communication and/or parallel interconnect systems. It can be used either to enhance the transmission performance of the transceiver, or to eliminate the need for bulky and/or expensive optical components to lower the cost. It can be used in the design of transponders, transceivers, and active cabling systems, for 10 Gb/s, 40 Gb/s, 100 Gb/s and other high bit rate transmission systems that utilize single mode or multi-mode fibers for serial or parallel transmission of high speed optical signals.

This U.S. application Ser. No. 12/132,616 is the official continuation filing of the previously filed provisional U.S. Patent Application No. 60/933,039, filed on Jun. 4, 2007, entitled “Dispersion tolerant electrical multi-level receivers and apparatus for low cost and high speed optical communications”, therefore claims the priority date of Jun. 4, 2007 of the provisional Patent Application U.S. 60/933,039, which is incorporated herein by reference.

### FIELD OF INVENTION

The invention relates to the design of optical transmission systems, and in particular, to electrical multi-level transmitter and/or receiver design and apparatus using such design for the modulation and/or demodulation in the communication systems for high-speed low-cost serial or parallel applications.

### BACKGROUND OF THE INVENTION

Optical fiber transmission systems are subject to distortion related to loss, noise, and nonlinearity in both the fiber and the modulation and amplification devices. One of the more deleterious forms of signal distortion is that due to chromatic dispersion.

Approaches currently used to reduce the effects of chromatic dispersion include: (1) using optical dispersion compensation (ODC) devices on the transmission line or at the receiver end prior to the optical to electrical conversion to reverse the effects of chromatic dispersion in the optical domain directly, (2) using the electrical dispersion compensation (EDC) based integrated circuit (IC) to reverse the effects in the electrical domain after optical detection, (3) using special modulation scheme and the modulator's phase at the transmitter to reduce the transmission bandwidth of the optical signal on the fiber, 4) using the electrical equalization schemes at the transmitter to pre-distort the transmission data bits per chromatic dispersion over the specific link before the modulation of the pre-compensated signals onto the optical carrier, and other methods as well.

The first is based on purely optical methods where the effects of group velocity dispersion are reversed while the signal is still in the optical domain. Adding dispersion compensating fiber in the transmission path is one common approach. Other optical methods include compensation by spectrally inverting the signal at the midpoint of the transmission path, see R. M. Jopson, A. H. Gnauck, R. M. Derosier, “10 Gb/s 360-km transmission over normal-dispersion fiber using mid-system spectral inversion,” Proceedings OFC'93, paper PD3, 1993, or pre-chirping the transmitted signal in an external modulator, see A. H. Gnauck, S. K. Korotky, J. J. Veselka, J. Nagel, C. T. Kemmerer, W. J. Minford, D. T. Moser, “Dispersion penalty reduction using an optical modulator with adjustable chirp,” IEEE Photonics Technology Letters, vol. 3, no. 10, pp. 916-918, October 1991. This type of approach is commonly used in the current commercial optical communication systems, but can be expensive, and bulky. Due to the large insertion loss of optical compensation devices, there is a need for more amplifiers to compensate the loss of the devices, which is not only expensive to implement and significantly increase the system cost from material, space, power, and operation perspective, but also introduce more of the unnecessary amplifier noises which in fact reduce the optical signal to noise ratio (OSNR) of the transmission system, and therefore may either significantly degrade the receiver signal or reduce the total allowed transmission distance. In the end, the cost of implementing these devices in the system is higher.

The second approach, in which dispersion effects are reversed in the electrical domain, is based on coherent transmission and homodyne detection followed by equalization in the electrical domain. Homodyne detection is only effective on single sideband signals. Some techniques proposed for post-detection equalization include the use of microstrip lines, see K. Iwashita, N. Takachio, “Chromatic dispersion compensation in coherent optical communications,” Journal of Lightwave Technology, vol. 8, no. 3, pp. 367-375, March 1990, and fractionally spaced equalizers, see J. H. Winters, “Equalization in coherent lightwave systems using a fractionally spaced equalizer,” Journal of Lightwave Technology, vol. 8, no. 10, pp. 1487-1491, October 1990. This type of coherent detection approach is expensive and only good for some applications. It is not generic enough to cover most of the applications, especially for most of the practical low cost optical communication systems, where only the direct detection system is used in majority of the commercial systems. Other approaches in the same category for the compensation of dispersion in the electrical domain after the optical to electrical conversion is the use of electrical dispersion compensator (EDC). This approach has seen only limited success in some applications, such as its use in low end applications in multimode fiber for 300 meter transmission and in single mode for 120 km transmission at 10 Gb/s. In fact, most of the current EDC chip can only compensate for a very small amount of the dispersion and the enhancement to the system is not significant enough, especially at high bit rate such as at 10 Gb/s and above. In addition, because of its requirement of the over sampling of the data stream, it requires the high speed electronics for signal processing, normally twice as much of the bit rate, so it is very challenging to implement EDC function for 40 Gb/s and 100 Gb/s system.

The third approach is to modify the transmission format so that the baseband signal spectrum is compressed. These types of approaches, which reduce the transmission bandwidth required on the fiber to transmit a given bit rate, are generally implemented by modifying the line code format in order to reduce the effective bandwidth required to transmit or receive the data, see K. Yonenaga, S. Kuwano, S. Norimatsu, N. Shibata, “Optical duobinary transmission system with no receiver sensitivity degradation,” Electronic Letters, vol. 31, no. 4, pp. 302-304, February 1995, and G. May, A. Solheim, J. Conradi, “Extended 10 Gb/s fiber transmission distance at 1538 nm using a duobinary receiver,” IEEE Photonics Technology Letters, vol. 6, no. 5, pp. 648-650, May 1994. There are various applications with respect to NRZ and RZ modulation utilizing the scheme on the transmitter side. The key benefit is that it reduces the spectral bandwidth compared with the normal NRZ modulation, and therefore is more dispersion tolerant for transmission. The key issue is the cost of the implementation of the transmitter. It requires the use of the more expensive and/or bulky MZ modulator and also the need to drive the modulator with 2 times of the normal driving voltage (i.e., 2V□ amplitude) compared with the standard NRZ modulation.

The fourth approach is to pre-compensate the transmitter based on the link dispersion so that there is no need for the dispersion compensating devices on the transmission line. This approach is good for long haul transmission, but is expensive for metro and access networks due to the use of complex modulation schemes and expensive MZ and various associated driving circuits. It requires the use of high power and high speed digital processing (DSP) capability implemented on the transmitter and receiver side, and therefore is quire costly.

With the rapid growth of internet and video traffic originated from the end users, the need for high bandwidth access and metro optical networks and parallel optical interconnect systems is also growing very fast. It is therefore highly desired that a cost effective high performance and high speed transmission system can be implemented in a simple and effective way to meet the ever increasing demand of bandwidth. It is therefore the objective of the present invention to employ a new and cost effective encoding and decoding scheme in the electronic domain to achieve either long reach high performance or short reach low cost optical transmission with the commercially readily available optical and electronic components and devices. It is also the objective for the present invention to address the applications for various different bit rates from 10 Gb/s to 40 Gb/s 100 Gb/s, and beyond, for either serial or parallel transmission in single mode or multi-mode fibers.

### SUMMARY OF THE INVENTION

This U.S. application Ser. No. 12/132,616 is the official continuation filing of the previously filed provisional U.S. Patent Application No. 60/933,039, filed on Jun. 4, 2007, entitled “Dispersion tolerant electrical multi-level receivers and apparatus for low cost and high speed optical communications”, and incorporated herein by reference.

The present invention is a method for optical transceiver design using readily available optical components, combined with the multi-level signal generation either at the transmitter or the receiver end, and with a multiple level decoder at the receiver end. It retains the simplicity of the existing modulation scheme and enhances the transmission system performance considerably and with much reduced cost.

Briefly, a preferred embodiment of a electrical multi-level transmitter or receiver of the present invention is a three level transmitter or receiver including a precoder and an encoder, which can generate a three level output electrical data stream (level 0, level 1 and level 2) based on the two level (level 0 and level 1) input data stream. This scheme can be implemented on either the transmitter side or the receiver side.

When the current invention is implemented on the receiver side, the electrical signal generated right after the photo detector will firstly pass this functional block of pre-coder and encoder so that the desired three-level electrical signals are generated. Then, the generated three level signals are split into two branches, one fed into the top level decision circuit (in this particular embodiment, using limiting amplifier) and another into the bottom level decision circuit (again, using limiting amplifier in this particular embodiment). The two detected signal streams are then combined into one final stream of NRZ data using a modulo-2 adder, which could be an exclusive OR gate (XOR).

An advantage of the present invention applied to the receiver side, is that on the transmitter side, most of the conventional and widely used intensity modulation schemes can still be practically used without need of modifications, such as the use of non-return-to-zero (NRZ) modulation or return-to-zero (RZ) modulation schemes. The cost of implementing these conventional NRZ or RZ modulation schemes is low and the components are readily available. Compared with the conventional direct detection system for the demodulation of NRZ or RZ signals, the multi-level receiver design also needs only one photo detector at the receiving end. However, the key difference between them is the introduction of the electrical multi-level generation scheme after the photo detection and the implementation of multi-level parallel decision making circuits following that. Compared with the traditional balanced detection scheme, such as these used in the differential phase shift keying (DPSK) and quadrature phase shift keying (QPSK), or the differential quadrature phase shifted keying (DQPSK) systems, instead of utilizing the optical delay line interferometers at optical domain before photo detectors and two or more balanced photo-detectors for the demodulation of phase information contained in the incoming optical signals, current scheme utilizes the electrical delay line architecture right after a single photo detector in the electrical domain and parallel multiple electrical decision making circuitries for the direct detection of the incoming optical signals.

When the current invention is implemented on both the transmitter side and the receiver side, the input electrical signal will firstly go through the functional block of pre-coder and encoder so that the desired three-level electrical signals are generated. The generated three level electrical signals are used directly to modulate an intensive modulator so that the optical modulated signals are the direct reflection of the electrical three level signals and therefore are also of three levels optically which normally are shown by the optical eye diagram, and should be different from other existing modulation schemes. By applying the three level electrical signals directly onto an intensity modulator such as the electro-absorption modulator (EA), instead of the more expensive or normally bulky phase modulator such as MZ modulator, the amplitude to phase conversion process is therefore eliminated on the transmitter side, so that the transmitter is simpler and less costly. The receiver side of the transceiver is implemented with the multiple level parallel decision making circuits to demodulate the incoming multiple level optical signals.

Therefore the key advantage of the present invention is the enhanced optical transmission performance, and/or the lower cost for the transmitter and receiver components, simpler physical implementation, and its universal appeal to the enhancement of many different types of direct detection based modulation systems.

These and other objects and advantages of the present invention will no doubt become obvious to those of ordinary skill in the art after having read the following detailed description of the best modes (or different embodiments) below.

### BRIEF DESCRIPTION OF THE DRAWINGS

The invention will now be described in great details with reference to the attached drawings, in which:

FIG. 1 is the schematic diagram of a transceiver according to an embodiment of the invention, where the multiple level electrical signal generation (encoder) and parallel decision making circuits (decoder) are implemented both on the receiver side of the transceiver.

FIG. 2 is the schematic diagram of a transceiver according to another embodiment of the invention, where the multiple level electrical signal generation (encoder) and the direct modulation of the multiple level signals onto an intensity modulator, while the parallel multiple level decision making circuits (decoder) is implemented on the receiver side.

FIG. 3(a) and FIG. 3(b) are the schematic diagrams of a ternary encoder and a ternary decoder implemented on the receiver side of the transceiver according to an embodiment of the invention, to demonstrate the principal of operations by the decoder, according to an embodiment of the invention.

### DESCRIPTION OF PREFERRED EMBODIMENTS

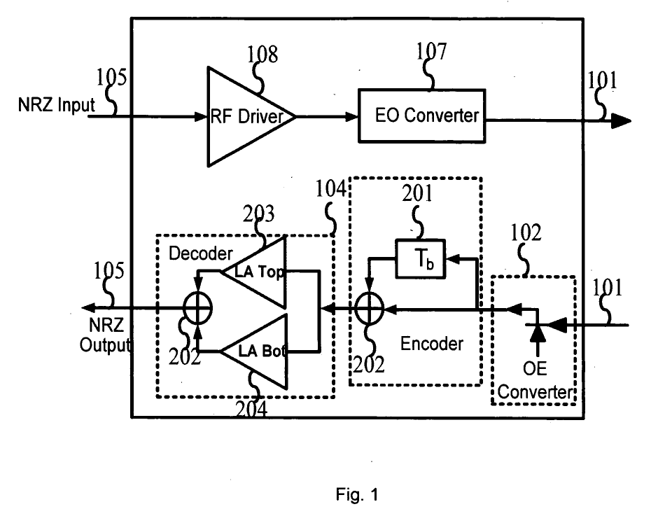

A transceiver according to an embodiment of the invention is shown in FIG. 1, where the present invention is implemented on the receiver side of the transmission system. The transceiver comprises a RF driver 108 and an electrical to optical convertor 107 on the transmitter chain. This transmitter chain is the typical implementation for NRZ system. The 107 block can be of other types of lasers and modulators to have the RZ, NRZ, Optical Single Side Band (OSSB) or Phase Shifted Binary Transmission (PSBT) modulation on the transmitter side. For example, the lasers can be the vertical cavity surface emitting lasers (VCSEL), or the FP lasers, or DFB lasers, or the external modulators can be of the MZ types, integrated, or hybrid integrated, or isolated from a CW laser. On the receiver chain, the received modulated light is firstly detected by a PIN or APD based photo detector 102 to perform the optical to electrical conversion. After that, the generated electrical signal is then fed into a multiple level electrical encoder 103, and in this embodiment, a ternary encoder 103, and is further sent to a multiple level electrical decoder 104, and in this case, a ternary decoder 104. Inside the ternary encoder, an electrical delay line structure is used to generate the ternary electrical signal, where the incoming signal is firstly split into two electrical paths, one feeding through directly, and the other being applied to with some time delay and also electrical signal attenuations in the combined complex amount of Tb 201, which is a complex number that represents both the time delay and the possible amplitude attenuation, and then both combined by an electrical combiner 202. The time delay implemented inside Tb 201 is normally of one bit period of the modulated signal in most of the case, but can be significantly shorter or significantly longer than one bit period of the incoming signal as well. For example, the delay can be of the amount of one quarter, one third, one half, two third of one bit period. The delay can also be of the continuously tunable from one value to the other, or of the switchable from one value to several of other values. The amount of the attenuations implemented in the delay line can also vary significantly, from no attenuation which is the typical implementation, to the attenuation of several decibels (dB) of the signals. The attenuation can be of tunable type or switchable types among several predefined values as well, in order to optimize the performance of the receiver, in conjunction with the various time delays. The optimization of the time delay and the signal attenuation is dependent on the incoming modulation schemes, which are tightly dependent on the implementation of the transmitter chain, the choice of optical components and the associated modulation schemes, and therefore can be different for different modulations.

More specifically, in the normal implementation, if there is no attenuation in the delay line 201, the Ternary Encoder 103 shown in FIG. 1 can consist of a FIR filter with a delay of 1 bit data Tb 201 and a modulo-2 adder 202 (for example: use the XOR gate). This can also be implemented with a 5th order Bessel Filter. The electrical output is then translated into a three-level ternary waveform after the encoder. The ternary signal after the encoder is then fed into a Ternary Decoder 104, which is then split into two branches, and fed into a pair of limiting amplifiers, one 203 in the upper branch and the other 204 in the lower branch, which make decisions for the ternary code. Two tributary outputs after the decision is combined by a modulo-2 adder 202 (for example: use the XOR gate) to transform the data stream back to its original NRZ binary code.

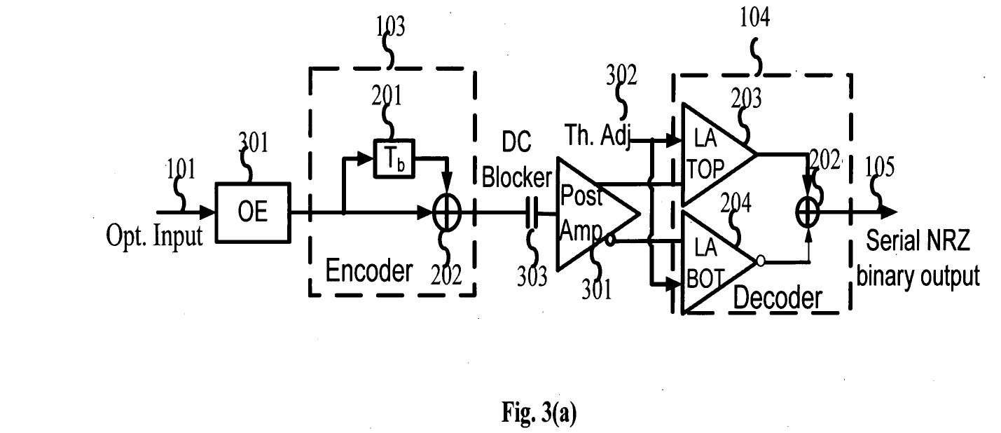

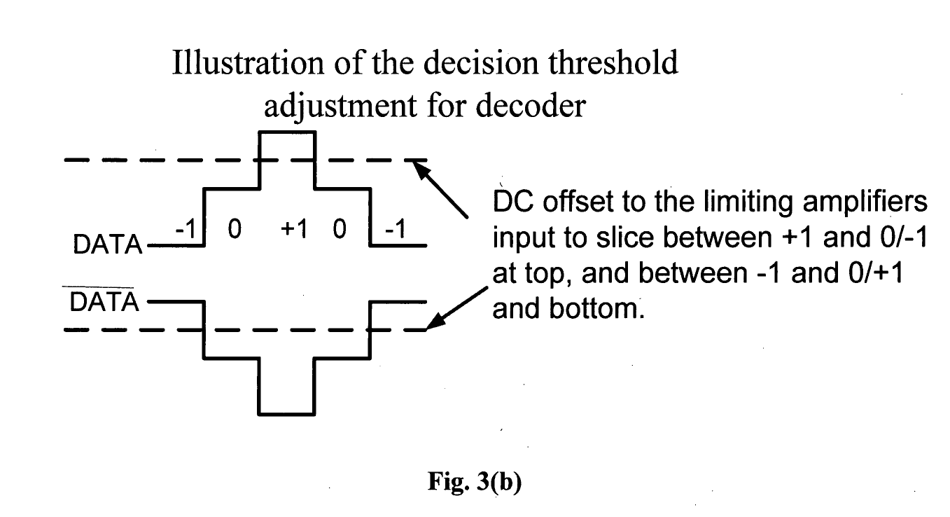

In order to further simplify the decision circuits and make it easy to find the optimum decision thresholds for both the top 203 and bottom 204 branches, for the purpose of demonstration of the principles of the operation, the thresholds 302 can be set together, according an embodiment of the invention as shown in FIG. 3(a), in such that they can actually work as one synchronized group, so that they can be adjusted through one common control 302 in order to slice through the electrical eyes for finding the best decision threshold, as also shown in FIG. 3(b). The electrical splitter function is simultaneously implemented using the post amplifier 301 with its two outputs DATA and its complementary DATA as the two inputs into the two limiting amplifiers 203 and 204. In order to further reduce the low frequency noise and cross talk, a DC blocker 303 is used between the encoder and the decoder, so that an AC coupling between them is ensured. It is noted that both the encoder 103 and the decoder 104 are implemented on the receiver side, one right after the order in the demodulation chain, only with AC coupling block 303 connecting them together. This is very different from other modulation and demodulation schemes where the encoder is normally implemented on the transmitter side, while the decoder is normally implemented on the receiver side of the chain.

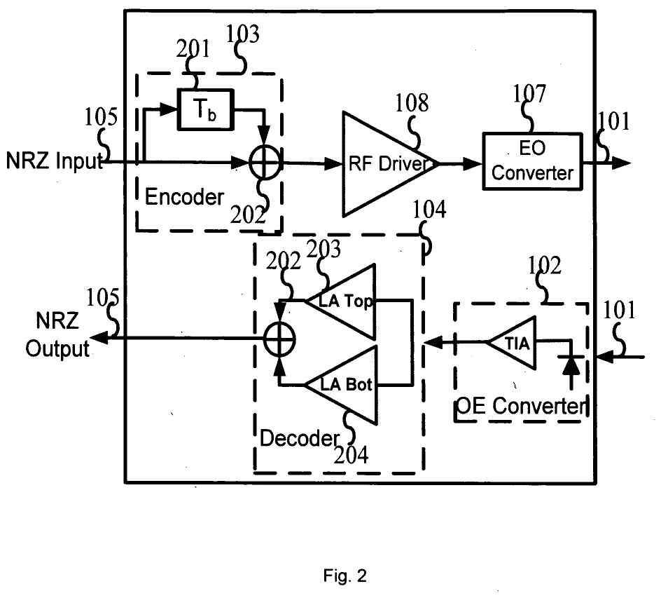

Nevertheless, a transceiver according to another embodiment of the invention is also shown in FIG. 2, where the present invention is implemented in such that the multiple level electrical encoder and the direct intensity modulation is on the transmitter side, while the multiple level parallel decision making circuits (the electrical decoder) is on the receiver side of the transmission system. In this embodiment, the incoming electrical signal is firstly got encoded by the encoder 103 to generate the three-level ternary electrical signals which are used to drive the RF driver 108 and then drive the electrical to optical convertor 107 to generate the three-level ternary optical waveform to feed into the optical fiber for transmission. On the receiver side, the incoming three-level optical waveform is firstly detected by a photo detector 102, either a PIN diode or an APD detector pending on the speed of the incoming signal. The detected electrical signal is of a three-level again, which is then further fed into the parallel multiple level decision making circuits 104, with the operation principles similar to these depicted in FIG. 1, FIG. 3(a) and FIG. 3(b) for the relevant demodulation blocks 104, and therefore the final NRZ bit stream is generated and fed into the digital processing portion of the transmission.

According to one embodiment of the present invention, an optical transponder with a CW laser and LiNbO3 MZ or EA modulator on the transmitter side with standard NRZ modulation and with the implementation of encoder 103 and decoder 104 of the present invention on the receiver side as shown in FIG. 1 can be constructed for 40 Gb/s operation. Such a NRZ 40 Gb/s transmitter without using the present invention on the receiver side cannot go beyond 50 ps/km with a clear eye opening (i.e. about 2 km in standard single mode fiber) with the conventional direct detection receiver. With the present invention implemented on the receiver side, the transmission distance can go beyond 220 ps/km (i.e., more than 10 km of single mode fiber) with a clear eye opening at 40 Gb/s, which is more than four to five times better than the system without the current invention. For transmission at 10 Gb/s bit rate, the present invention can also achieve more than four to five times better transmission distance of around 320 km of non-compensated reach, compared with about 60 km to 80 km reach of the same transmitter without the use of the present invention on the receiver side.

According to another embodiment of the present invention, a low speed direct modulated VCSEL or FP laser inherently capable of 10 Gb/s operation can be used for 20 Gb/s multi-mode application by implementation of the present invention. Similarly, a VCSEL or FP capable of 20 Gb/s direct modulation can be used for 40 Gb/s multi-mode applications by using the present invention. The present invention can be used in conjunction with low cost VCSEL or FP laser for extremely low cost optical parallel interconnect applications at the speed of 20 Gb/s or above, or for very low cost 100 Gb/s application by using four of such VCSEL or FP capable of working at 25 Gb/s each.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the present invention.

What is claimed is:

1. An optical transceiver, comprising: a multiple level encoder for encoding either the incoming data on the transmitter side or the received electrical signal after the optical to electrical conversion into a multiple level electrical signal, and, a multiple level decoder utilizing parallel decision circuits and other combination logic to combine the multiple signals from each branch together so as to demodulate the multiple level electrical signal and make it into the NRZ binary signal for further digital processing. One of the embodiments is that the said multiple level electrical signals are ternary signals, therefore the encoder is a ternary encoder, and the decoder is a ternary decoder.

2. The transceiver of claim 1, wherein: both the said multiple level encoder and the multiple level decoder are used together on the receiver end;

3. The transceiver, wherein: the said multiple level encoder is on the transmitter side and the said multiple level decoder is on the receiver end.

4. The transceiver of claim 1, wherein: the multiple level encoder and decoder are used on the receiver side, while the transmitter side can be of the following types with NRZ modulation, such as directly modulated VCSEL, FP or DFB lasers, externally modulated laser and modulator assembly with fixed or tunable wavelength CW lasers and LiNbO3 or InP MZ modulators, or hybrid integrated or monolithically integrated laser and modulator devices, and various NRZ modulation implementation using different types of laser technologies such as the chirp managed lasers, external cavity lasers, and etc.

5. The transceiver of claim 1, wherein: the multiple level encoder and decoder are used on the receiver side, while the transmitter side can be of the following types with other types of modulation schemes, such as the standard RZ modulation, carrier suppressed RZ modulation (CS-RZ), optical single side band NRZ or RZ modulation (OSSB), chirped RZ modulation (CRZ), phase shaped binary transmission with RZ or NRZ modulation (PSBT), chirped managed lasers with RZ modulation (CML-RZ), and etc.

6. The transceiver of claim 1 and 2, wherein: the said encoder and decoder can work with various bit rate from 100 Mb/s all the way to 100 Gb/s, or any other rates applicable. For each rate, the receiver implementation might be different due to the selection of electronic and optical components, but the architecture on the receiver side for the encoder and decoder shall remain the same, or similar with minor alterations evident or obvious for those with ordinary skills and/or arts in the field.

7. The transceiver of claim 1, wherein: the encoder and decoder can work with other modulation schemes on the receiver end right after each of the photo detectors. The applicable modulation formats include different variations of DPSK, QPSK, and DQPSK, and etc. In each of those embodiments applicable to the above modulation schemes, the present invention of claim 1 can be implemented right after the optical to electrical conversion after the direct photo detection. For the balanced detection, with dual or more photo detectors, the present embodiment in claimed 1 can be used after each of the photo detectors to improve the dispersion limit considerably for each of the modulation schemes without noticeably impact the cost of the receivers.

8. The transceiver of claim 1 and 2, wherein: the encoder and decoder are made of digital signal processing units that can convert the binary electrical signal (in the form of 0 and 1, where 1 represent the maximum amplitude) into three level signal. The three level electrical signals can be in all the positive formats such as those represented by digital signals (0, 1, 2). Or alternatively, in the form of balanced format such as those represented by the digital signals (−1, 0, +1), where DC content is eliminated and only AC coupling is required.

9. The transceiver of claim 1 and 2, wherein: the precoder and encoder right after the optical to electrical conversion is made of digital signal processing units that can convert the binary electrical signal into three level signal. It can be realized by the digital or analog means through the use of a one-bit period delay line in parallel with the precoder and the encoder before the two branches are combined together again. Or alternatively, it can be realized similarly using the feed forward equalization (FFE) schemes by utilizing either 2-tap one-bit delay with equalized weighting parameters (50% splitting and combining ratio), or the 3-tap feed forward equalization (FFE) scheme with half-bit period delay between taps and the second tap coefficient being set to zero while the other two coefficients are set to equal.

10. The transceiver of claim 1 and 2, wherein: the multiple level parallel decision circuits can have various embodiments. The common key functions are the detection and separation of the upper most bit pulse from the other bit pulses through the top decision circuit and, the detection and separation of the lower most bit pulse from the other bit pulses though the bottom decision circuit. It provides more bit redundancy so that it is more tolerant to fiber transmission impairments, especially to the impairments caused by the fiber chromatic dispersion which is normally linear to transmitted fiber length.

11. An optical transceiver of claim 1 and 2, comprising: an encoder for encoding the driving signal on the transmitter end or the received electrical signal after the photo detection into a multi-level electrical signal (M levels, where M is an integer and is larger than or equal to 3), a decoder which demodulates the M level electrical signal at the receiver end through M-level threshold decision detection circuits. This scheme utilizes the low speed parallel decision circuits (each branch is delayed by normally additional bit period, compared with previous adjacent branch) to decode the high speed serial signal. In such, this scheme is suitable for 40 Gb/s, 100 Gb/s and other high speed optical signals.

12. The transceiver of claim 1 and 2, wherein: the delay between any two adjacent parallel branches is either equal to each other, or having a different delay time. The delay time between branches can be that of one bit period, or a period that is less or more than one bit in comparison with the signal rate. The preferred embodiment is to use the delay time between branches being equal or close to one signal bit period.
